(19) United States
(12) Patent Application Publication
(10) Pub. No.: US 2025/0386367 A1
(43) Pub. Date: Dec. 18, 2025

(54) METHODS AND APPARATUSES FOR S-SSB TRANSMISSION IN AN UNLICENSED SPECTRUM

(71) Applicant: LENOVO (BEIJING) LIMITED, Beijing (CN)

(72) Inventors: Xin Guo, Beijing (CN); Haipeng Lei, Beijing (CN); Xiaodong Yu, Beijing (CN); Zhennian Sun, Beijing (CN)

(21) Appl. No.: 18/879,625

(22) PCT Filed: Jun. 29, 2022
(86) PCT No.: PCT/CN2022/102565

§ 371 Date: Dec. 27, 2024

(51) Int. Cl. H04W 74/0808; H04W 56/00

(52) U.S. Cl. CPC H04W 74/0808; H04W 56/0015

(57) ABSTRACT

Embodiments of the present disclosure relate to methods and apparatuses for sidelink synchronization signal block (S-SSB) transmission in an unlicensed spectrum. According to an embodiment of the present disclosure, a user equipment (UE) can include: a processor configured to: obtain configuration information for S-SSB in an unlicensed spectrum based on configuration or pre-configuration, wherein the configuration information includes at least one of the following: a first configuration associated with a time interval between adjacent S-SSB occasions sharing a same channel occupancy time (COT); a second configuration for performing listen before talk (LBT) type 2; or a third configuration for performing LBT type 1; and perform an LBT procedure associated with an S-SSB occasion based on the configuration information; a transmitter coupled to the processor and configured to transmit an S-SSB on the S-SSB occasion in response to the LBT procedure being successful; and a receiver coupled to the processor.

### TECHNICAL FIELD

Embodiments of the present application are related to wireless communication technology, and more particularly, related to methods and apparatuses for sidelink (SL) synchronization signal block (SSB) transmission in an unlicensed spectrum.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in an SL SSB (S-SSB). In an unlicensed spectrum, before an S-SSB transmission, a channel access procedure may be performed. Therefore, new designs for S-SSB transmission in an unlicensed spectrum are needed.

SUMMARY OF THE APPLICATION

Embodiments of the present application at least provide a technical solution for S-SSB transmission in an unlicensed spectrum.

According to some embodiments of the present application, a UE may include a processor configured to: obtain configuration information for S-SSB in an unlicensed spectrum based on configuration or pre-configuration, wherein the configuration information includes at least one of the following: a first configuration associated with a time interval between adjacent S-SSB occasions sharing a same channel occupancy time (COT); a second configuration for performing listen before talk (LBT) type 2; or a third configuration for performing LBT type 1; and perform an LBT procedure associated with an S-SSB occasion based on the configuration information; a transmitter coupled to the processor and configured to transmit an S-SSB on the S-SSB occasion in response to the LBT procedure being successful; and a receiver coupled to the processor.

In some embodiments of the present application, the configuration information is based on at least one of the following granularities: per channel bandwidth, per carrier, per bandwidth part, per frequency range, or per subcarrier spacing (SCS).

In some embodiments of the present application, the receiver is configured to receive the configuration information via at least one of: a master information block (MIB) message, a system information block (SIB) message, a radio resource control (RRC) signaling, or a medium access control (MAC) control element (CE).

In some embodiments of the present application, the first configuration indicates at least one of: a length of the time interval; a location of the time interval; or a construction of the time interval.

In some embodiments of the present application, the time interval occupies one or more orthogonal frequency division multiplexing (OFDM) symbols, and a number of OFDM symbols included in the time interval is determined based on a maximum length of a sensing interval for performing an LBT procedure and SCS.

In some embodiments of the present application, the construction of the time interval includes at least one of: a length of a sensing interval for performing an LBT procedure, a location of the sensing interval, or a content for padding in the time interval.

In some embodiments of the present application, the location of the sensing interval is immediately after a previous symbol adjacent to the time interval or immediately prior to a next symbol adjacent to the time interval; or the content for padding in the time interval is a full or partial copy of a symbol adjacent to the time interval or a cyclic prefix extension (CPE) of a first symbol in an S-SSB occasion next to the time interval.

In some embodiments of the present application, the second configuration indicates at least one of: an LBT type; a unit of time for calculating a length of a CPE; a mapping between the number(s) of units of time for calculating a length of a CPE and priority(ies) for synchronization reference; or a maximum channel occupancy time (MCOT) for S-SSB.

In some embodiments of the present application, a higher priority for synchronization reference is mapped to the number of units of time associated with a longer CPE.

In some embodiments of the present application, the third configuration indicates at least one of: an LBT type; a first mapping between channel access priority class (CAPC) value(s) and priority(ies) for synchronization reference; a second mapping between CAPC value(s) and length(s) of COT(s) for S-SSB; or an MCOT for S-SSB.

In some embodiments of the present application, a higher priority for synchronization reference is mapped to a smaller CAPC value.

In some embodiments of the present application, a shorter length of a COT for SSB is mapped to a smaller CAPC value.

In some embodiments of the present application, the MCOT for S-SSB is defined as a maximum number of S-SSBs to be transmitted within one COT or defined as a maximum channel occupancy time for consecutive S-SSB transmissions.

In some embodiments of the present application, the processor is configured to: perform the LBT procedure associated with the S-SSB occasion in a sensing interval, wherein a length of the sensing interval is determined based on the LBT type; and the transmitter is further configured to transmit the CPE to occupy a channel until a starting boundary of the S-SSB occasion in response to the LBT procedure being successful.

In some embodiments of the present application, the configuration information further includes at least one of the followings: a maximum number of S-SSBs to be transmitted within one S-SSB period; or a maximum number of S-SSBs to be transmitted within one S-SSB window.

According to some other embodiments of the present application, a BS may include: a transmitter configured to: transmit configuration information for S-SSB in an unlicensed spectrum, wherein the configuration information includes at least one of the following: a first configuration associated with a time interval between adjacent S-SSB occasions sharing a same COT; a second configuration for performing LBT type 2; or a third configuration for performing LBT type 1; and a processor coupled to the transmitter; and a receiver coupled to the processor.

According to some other embodiments of the present application, a method performed by a UE may include: obtaining configuration information for S-SSB in an unlicensed spectrum based on configuration or pre-configuration, wherein the configuration information includes at least one of the following: a first configuration associated with a time interval between adjacent S-SSB occasions sharing a same COT; a second configuration for performing LBT type 2; or a third configuration for performing LBT type 1; performing an LBT procedure associated with an S-SSB occasion based on the configuration information; and transmitting an S-SSB on the S-SSB occasion in response to the LBT procedure being successful.

According to some other embodiments of the present application, a method performed by a BS may include: transmitting configuration information for S-SSB in an unlicensed spectrum, wherein the configuration information includes at least one of the following: a first configuration associated with a time interval between adjacent S-SSB occasions sharing a same COT; a second configuration for performing LBT type 2; or a third configuration for performing LBT type 1.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary S-SSB slot according to some embodiments of the present disclosure;

FIG. 3 illustrates an exemplary distribution of occasions for S-SSB according to some embodiments of the present disclosure;

FIG. 4 illustrates a flowchart of an exemplary method for S-SSB transmission in an unlicensed spectrum according to some embodiments of the present application;

FIG. 5 illustrates exemplary time domain structures for a time interval between two adjacent S-SSBs according to some embodiments of the present application;

FIG. 6 illustrates exemplary time domain structures for a time interval between two adjacent S-SSBs according to some other embodiments of the present application;

FIG. 7 illustrates an exemplary time domain structure for performing LBT type 2 according to some embodiments of the present application;

FIG. 8 illustrates an exemplary time domain structure for performing LBT type 1 according to some embodiments of the present application;

FIG. 9 illustrates an exemplary distribution of S-SSB occasions within one S-SSB period according to some embodiments of the present application; and

FIG. 10 illustrates a simplified block diagram of an exemplary apparatus for S-SSB transmission in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

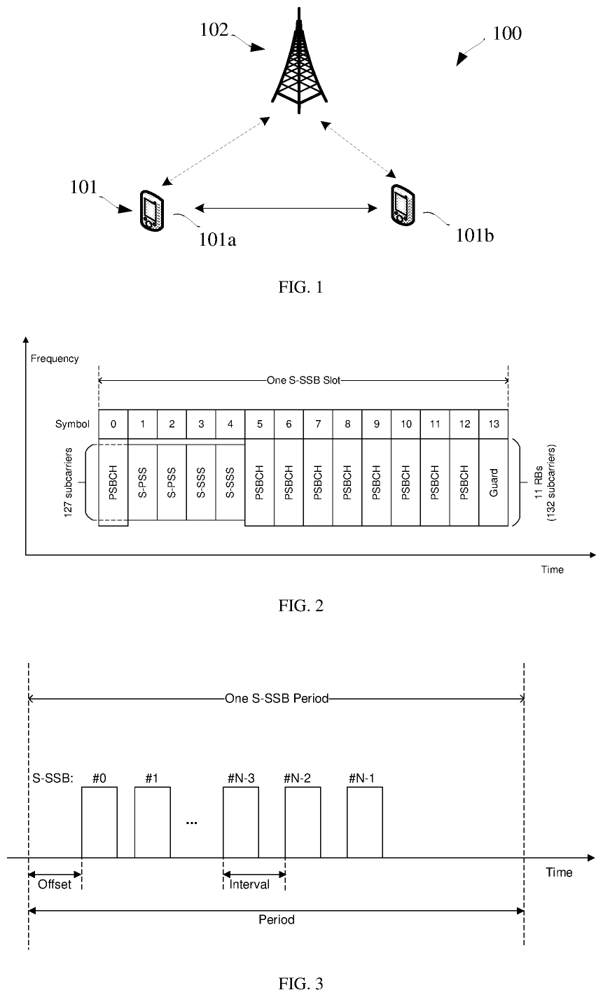

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present disclosure, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an OFDM modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a COT. During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on LBT, where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least a period referred to as a defer period. The defer period may consist of 16 μs and a number (e.g., “mₚ” in the following Table 1 or Table 2, which will be illustrated below) of 9 μs slots. As shown in Table 1 and Table 2, a value of “mₚ” depends on a value of CAPC (represented as “p”). Accordingly, the defer period depends on the value of CAPC as shown in the following Table 1 or Table 2. A channel is declared to be available if the received energy during at least 4 μs of each 9 μs slot is below a threshold.

Once the channel has been declared available during the defer period, the transmitter starts a back-off procedure during which it will wait a random period of time.

The UE starts the back-off procedure by initializing a back-off timer with a random number within a contention window (CW). The random number is drawn from a uniform distribution [0, CW] and represents that the channel must be available for a timer duration (e.g., defined by the random number multiplying 9 μs) before transmission can take place. The value of “CW” may be selected from “allowed CWₚ sizes” (the minimum value is represented as CW_{min,p}, and the maximum value is represented as CW_{max,p}) in the following Table 1 or Table 2, which depends on a value of CAPC.

The back-off timer is decreased by one when each 9 μs duration the channel is sensed to be idle; whenever the channel is sensed to be busy, the back-off timer is put on hold until the channel has been idle for a defer period.

Once the back-off timer has expired (e.g., the back-off timer is decreased to be 0), the random back-off procedure is completed, and the transmitter has acquired the channel and can use it for transmission up to MCOT (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CW_{min,p}, CW_{max,p}, T_{mcot,p}, T_{ulmcot,p}, and allowed CWₚ sizes. Table 1 is the same as Table 4.1.1-1 in, TS 37.213 and Table 2 is the same as Table 4.2.1-1 in TS 37.213. When a BS intends to initiate a COT for DL transmission, it may determine a CAPC value before performing a Type-1 channel access procedure, and then determine the corresponding values (e.g., mₚ, CW_{min,p}, CW_{max,p}, T_{mcot,p}, and allowed CW_{P} sizes) used in the Type-1 channel access procedure according to Table 1. When a UE intends to initiate a COT for UL transmission, it may determine a CAPC value before performing a Type-1 channel access procedure, and then determine the corresponding values (e.g.,, mₚ, CW_{min,p}, CW_{max,p}, T_{ulcot,p}, and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | |
| Class (p) | mₚ | CW_{min, p} | CW_{max. p} | T_{mcot, p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

TABLE 2
Channel Access Priority Class for UL

| Channel | | | | | |
|---|---|---|---|---|---|
| Access | | | | | |
| Priority | | | | | |
| Class (p) | mₚ | CW_{min, p} | CW_{max. p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further divided into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 μs immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions. FIG. 3 illustrates an exemplary distribution of occasions for S-SSB according to some embodiments of the present disclosure.

As shown in FIG. 3, within one S-SSB period, N S-SSB occasions are included, which are S-SSB #0, S-SSB #1, . . . , S-SSB #N-3, S-SSB #N-2, and S-SSB #N-1, respectively. A length of the S-SSB period is marked as “Period.” There is an offset from the starting slot of the S-SSB period to the first S-SSB occasion within the S-SSB period, e.g., S-SSB #0, which is marked as “Offset” in FIG. 3. There is an interval between two adjacent S-SSB occasions (e.g., between starting slots of the two adjacent S-SSB occasions). For example, as shown in FIG. 3, the interval between S-SSB #N-3and S-SSB #N-2 is marked as “Interval.” Accordingly, the configuration for one S-SSB period may include at least one of the parameter “Period,” the parameter “Offset,” or the parameter “Interval.” A UE may select one or more SSB occasions for transmitting SSB(s) based on the configuration.

The S-SSB period may include 16 frames, e.g., 160 ms, as specified in NR V2X. Possible numbers of S-SSB occasions within one S-SSB period are shown in the following Table 3:

TABLE 3
Number of S-SSB occasions within an S-SSB Period (160 ms)

| Frequency | Subcarrier spacing | Number of S-SSB occasions per |
|---|---|---|
| range | (SCS) | period |
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

The structure of S-SSB slot in FIG. 2 and distribution of occasions for S-SSB in FIG. 3 are only for illustrative purpose. It is contemplated that along with developments of network architectures and new service scenarios, the S-SSB may have other structures (for example, the S-SSB may include 4 OFDM symbols in the time domain) and the distribution of occasions for S-SSB within one S-SSB period may change, which should not affect the principle of the present application.

For an S-SSB transmission in an unlicensed spectrum, in the time domain, one important requirement is that a UE needs to perform a channel access procedure (e.g., an LBT procedure) before the S-SSB transmission.

Compared to the licensed spectrum, more S-SSB occasions may be needed for the unlicensed spectrum for the following two reasons. One is to achieve desirable channel access opportunities for UE. The other is for S-SSB to be used in new scenarios, such as supporting latency-critical traffics, supporting beam-based transmission, and so on.

In addition, if accessing each S-SSB occasion needs an independent LBT procedure with a long time, the energy consumption will be scaled largely with the number of S-SSB transmissions.

Given the above, how to support S-SSB transmission (e.g., COT-based S-SSB transmission or a single S-SSB transmission) in unlicensed spectrum needs to be addressed.

Embodiments of the present application provide improved solutions for S-SSB transmission in an unlicensed spectrum, which propose configurations, signalings, and procedures for implementing a channel access procedure (or an LBT procedure) before an S-SSB transmission, thereby supporting COT-based S-SSB transmission in unlicensed spectrum. More details will be described in the following text in combination with the appended drawings.

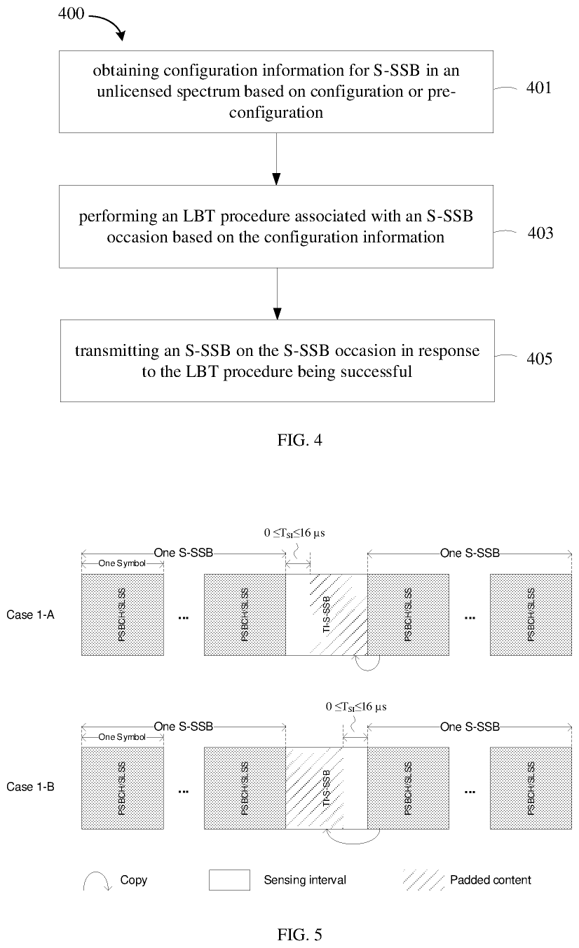

FIG. 4 illustrates a flowchart of an exemplary method 400 for S-SSB transmission in an unlicensed spectrum according to some embodiments of the present application. The method 400 illustrated in FIG. 4 may be performed by a UE (e.g., UE 101a or UE 101b in FIG. 1) or other apparatus with the like functions.

As shown in FIG. 4, in step 401, a UE may obtain configuration information for S-SSB in an unlicensed spectrum based on configuration or pre-configuration; in step 403, the UE may perform an LBT procedure associated with an S-SSB occasion based on the configuration information; in step 405, the UE may transmit an S-SSB on the S-SSB occasion in response to the LBT procedure being successful.

In some embodiments of the present application, the UE may obtain the configuration information based on configuration. Specifically, obtaining the configuration information based on configuration (i.e., the configuration information is configured to the UE) may refer to that: the configuration information is transmitted by a BS (e.g., BS 102 as shown in FIG. 1) to the UE via at least one of: a SIB message, a MIB message, an RRC signaling, or a MAC CE, or downlink control information (DCI), such that the UE may receive the configuration information from the BS. In an embodiment of the present application, obtaining the configuration information based on configuration may apply to the scenario where the UE is in coverage of a network.

In some other embodiments of the present application, the UE may obtain the configuration information based on pre-configuration. Specifically, obtaining the configuration information based on pre-configuration (i.e., the configuration information is pre-configured to the UE) may refer to that: the configuration information may be hard-wired into the UE or stored on a subscriber identity module (SIM) or universal subscriber identity module (USIM) card for the UE, such that the UE may obtain the configuration information within the UE. In an embodiment of the present application, obtaining the configuration information based on pre-configuration may apply to the scenario where the UE is out of coverage of the network.

In some embodiments of the present application, the configuration information may be based on at least one of the following granularities: per channel bandwidth, per carrier, per bandwidth part, per frequency range, or per SCS.

The configuration information may include at least one of: a first configuration associated with a time interval (e.g., denoted as TI-S-SSB) between adjacent S-SSB occasions sharing a same COT; a second configuration for performing LBT type 2; or a third configuration for performing LBT type 1.

The first configuration may be used for supporting consecutive S-SSB transmissions within a same COT. The time interval determined based on the first configuration may be used between adjacent S-SSB occasions which may have any structures in the time domain and in the frequency domain. For example, an S-SSB occasion may have a structure as shown in FIG. 2, wherein an S-SSB occasion occupies one slot in the time domain. In another example, an S-SSB occasion may occupy 4 symbols (e.g., OFDM symbols) in the time domain. In some other example, an S-SSB occasion may occupy any other number of symbols in the time domain.

The first configuration associated with a time interval may consider the following features.

In some embodiments, in order to support consecutive S-SSB transmissions, one important feature is a sensing interval for channel access between two adjacent S-SSB occasions, regardless of how many symbols an S-SSB occasion occupies (e.g., 4 symbols, one slot, and so on). Accordingly, the time interval may include a sensing interval.

The duration of the sensing interval may be set according to the following considerations.

On one hand, a short sensing interval duration is expected such that more S-SSB occasions can be obtained for a given time duration of resources for S-SSB transmission. In some extreme cases, two adjacent S-SSB occasions may distribute in the time domain in a consecutive way without any gap therebetween.

On the other hand, a long sensing interval duration is expected such that sufficient time can be guaranteed for performing channel access procedure prior to each S-SSB occasion. In that case, the duration of the sensing interval may depend on the LBT type to be used.

In addition, the duration of the sensing interval may also need to consider a gap (e.g., one symbol) for support a switch between transmitting and receiving for a same UE.

In some embodiments, to guarantee that an S-SSB transmission is aligned with the OFDM symbol boundaries, the time interval between adjacent S-SSB occasions may include a positive integer number of OFDM symbols.

Given the above, the first configuration associated with a time interval may indicate at least one of: a length of the time interval; a location of the time interval; or a construction of the time interval

The time interval may occupy one or more OFDM symbols. In some embodiments, the length of the time interval may be defined by the number of the OFDM symbols included in the time interval. In some other embodiments, the length of the time interval may be defined by a time duration which is multiples of a time duration of an OFDM symbol. The number of OFDM symbols included in the time interval may be determined based on a maximum length of a sensing interval for performing an LBT procedure and SCS. For example, for a given SCS, if a maximum length of a sensing interval for performing an LBT procedure is no longer than one OFDM symbol, then one OFDM symbol may be sufficient to be the time interval. Otherwise, more OFDM symbols may be needed.

A time interval may locate between two adjacent S-SSB occasions (e.g., between two adjacent S-SSB occasions within a same COT). For example, a time interval may be immediately between adjacent S-SSB occasions. In other words, the time interval is immediately after the last symbol of one S-SSB occasion of the two adjacent S-SSB occasions and immediately before the first symbol of the other S-SSB occasion of the two adjacent S-SSB occasions.

The location of the time interval is adaptive to any S-SSBs as defined in the current 3GPP standard documents and to be defined in the future 3GPP standard documents. For example, if an S-SSB occupies 4 OFDM symbols in the time domain, the time interval may locate at the symbol(s) right before each S-SSB. In another example, if an S-SSB occupies 13 OFDM symbols in a slot, the time interval may locate at the last symbol, i.e., the 14^{th} symbol, of the slot containing the S-SSB.

The time interval may be fully or partially padded with certain content to obtain a desired length of a sensing interval for performing an LBT procedure. Accordingly, the construction of the time interval may include at least one of: a length of a sensing interval for performing an LBT procedure, a location of the sensing interval, or a content for padding in the time interval.

According to the padded content in the time interval, the construction of the time interval may include the following two cases, i.e., case 1 and case 2.

In case 1, the content for padding in the time interval is a full or partial copy of a symbol adjacent to the time interval such that a sensing interval within the time interval is no greater than 16 μs. For example, the symbol adjacent to the time interval may be a previous symbol adjacent to the time interval or a next symbol adjacent to the time interval. In other words, in case 1, the time interval is one OFDM symbol and a Type 2C dynamic channel access procedure is applied, therefore no idle sensing is required between S-SSBs.

According to the location of the sensing interval in the time interval, case 1 may further include case 1-A and case 1-B. In case 1-A, the location of the sensing interval is immediately after a previous symbol adjacent to the time interval. In case 1-B, the location of the sensing interval is immediately prior to a next symbol adjacent to the time interval.

FIG. 5 illustrates exemplary time domain structures for a time interval between two adjacent S-SSBs according to some embodiments of the present application. Specifically, FIG. 5 shows two exemplary time domain structures for a time interval in case 1-A and case 1-B.

In FIG. 5, for both cases 1-A and 1-B, the length of the time interval is one symbol, and the length of the sensing interval (e.g., denoted as T_{SI}) is no greater than 16 μs, i.e., 0≤T_{SI}≤16 μs.

For case 1 -A in FIG. 5, the time interval contains a full or partial copy of a next symbol adjacent to the time interval. For example, the next symbol may carry a PSBCH or SLSS. The sensing interval locates immediately after a previous symbol adjacent to the time interval. That is, the sensing interval locates at the starting of the time interval.

For case 1 -B in FIG. 5, the time interval contains a full or partial copy of a next symbol adjacent to the time interval. For example, the next symbol may carry a PSBCH or SLSS. The sensing interval locates immediately prior to the next symbol adjacent to the time interval. That is, the sensing interval locates at the end of the time interval.

In case 2, the content for padding in the time interval is an extension of CP (which is referred to as CPE) of a first symbol in an S-SSB occasion next to the time interval. The length of the sensing interval (e.g., denoted as T_{SI}) may be 0≤T_{SI}23 16 μs, T_{SI}=16 μs or T_{SI}>25 μs, which correspond to LBT type 2 C, LBT type 2 B or LBT type 2 A, respectively. For a given length of the time interval (e.g., denoted as T_{TI-S-SSB}), the length of the CPE (e.g., T_{CPE}) may be used to obtain a desired sensing interval T_{SI} , based on the following equation (1):

$${T}_{TI - S - SSB} = {T}_{SI} + {T}_{CPE} . \qquad ( 1 )$$

Accordingly, case 2 may be applied for Type 2A dynamic channel access procedure, Type 2B dynamic channel access procedure, and Type 2C dynamic channel access procedure.

According to the location of the sensing interval in the time interval, case 2 may further include case 2-A and case 2-B. In case 2-A, the location of the sensing interval is immediately after a previous symbol adjacent to the time interval. In case 2-B, the location of the sensing interval is immediately prior to a next symbol adjacent to the time interval.

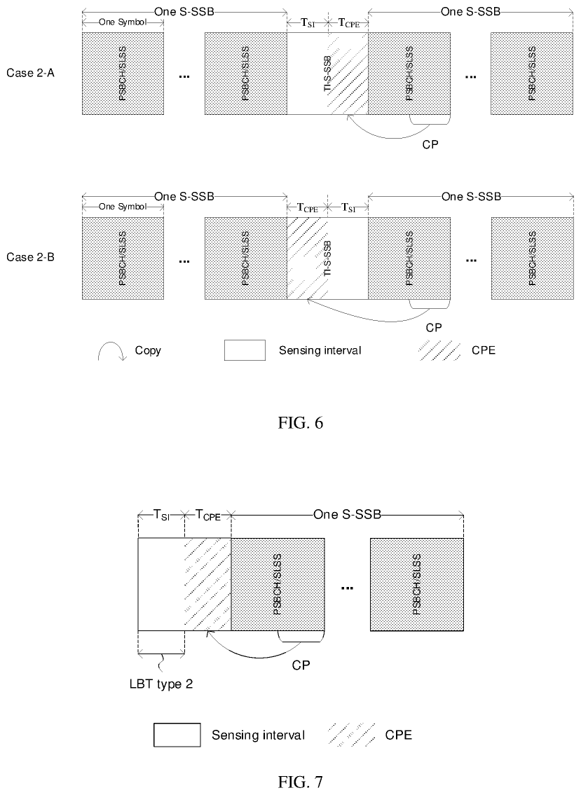

FIG. 6 illustrates exemplary time domain structures for a time interval between two adjacent S-SSBs according to some embodiments of the present application. Specifically, FIG. 6 shows two exemplary time domain structures for a time interval in case 2-A and case 2-B.

In the example of FIG. 6, for both cases 2-A and 2-B, the length of time interval is one symbol, and the length of the sensing interval (e.g., denoted as T_{SI}) is determined based on LBT type (e.g., LBT type 2 C, LBT type 2 B or LBT type 2 A) as stated above.

For case 2-A in FIG. 6, the time interval contains a CPE of a first symbol in an S-SSB occasion next to the time interval, wherein the length of the CPE is denoted as T_{CPE}. For example, the first symbol in the next S-SSB occasion may carry a PSBCH or SLSS. The sensing interval locates immediately after a previous symbol adjacent to the time interval. That is, the sensing interval locates at the starting of the time interval.

For case 2-B in FIG. 6, the time interval contains a CPE of a first symbol in an S-SSB occasion next to the time interval, wherein the length of the CPE is denoted as T_{CPE}. For example, the first symbol in the next S-SSB occasion may carry a PSBCH or SLSS. The sensing interval locates immediately prior to a next symbol adjacent to the time interval (i.e., the first symbol in the next S-SSB occasion). That is, the sensing interval locates at the end of the time interval.

After obtaining the first configuration, in step 403, the UE may perform an LBT procedure associated with an S-SSB occasion based on the first configuration. For example, for any S-SSB occasion within a COT except for the first S-SSB occasion within the COT, before transmitting the S-SSB on the S-SSB occasion, the UE may perform an LBT procedure in the sensing interval within the time interval configured by the first configuration. In step 405, the UE may transmit an S-SSB on the S-SSB occasion in response to the LBT procedure being successful.

In some embodiments, the sensing interval may be located before the content for padding in the time interval. Then, in step 403, the UE may perform an LBT procedure in the sensing interval within the time interval. In response to the LBT procedure being successful, the UE may transmit the content for padding to occupy a channel until a starting boundary of the S-SSB occasion. Then, in step 405, the UE may transmit an S-SSB on the S-SSB occasion. Taking case 2-A as an example, the UE may perform idle sensing within a duration of T_{SI} in step 403. Then, the UE may occupy the channel by performing CPE with a duration of T_{CPE} (e.g., transmitting the CPE within a duration of T_{CPE}) once the channel is determined to be idle (i.e., the LBT procedure is successful). After that, the UE may transmit an S-SSB on the S-SSB occasion.

In some embodiments, the sensing interval may be located after the content for padding in the time interval. Then, the UE may first transmit the content for padding, and then perform an LBT procedure in the sensing interval in step 403. In step 405, the UE may transmit an S-SSB on the S-SSB occasion in response to the LBT procedure being successful. Taking case 2-B as an example, the UE may first occupy the channel by performing CPE with a duration of T_{CPE} (e.g., transmitting the CPE within a duration of T_{CPE}), and then the UE may perform idle sensing within a duration of T_{SI} in step 403. In step 405, the UE may transmit an S-SSB on the S-SSB occasion in response to the LBT procedure being successful.

The second configuration may be used for supporting LBT type 2. For example, the second configuration may be used for supporting LBT type 2 associated with a single S-SSB occasion (e.g., before transmitting a single S-SSB). In another example, the second configuration may be used for supporting LBT type 2 associated with a first S-SSB occasion within a COT (e.g., before transmitting a first S-SSB within a COT). That is, the second configuration may be used to initiate a COT-based S-SSB transmission.

In order to support LBT type 2, the length of the sensing interval (e.g., denoted as T_{SI}) for performing LBT may be determined by a LBT type (e.g., Type 2A, Type 2B, or Type 2C). For example, in the case of Type 2A dynamic channel access procedure, T_{SI}>25 μs; in the case of Type 2B dynamic channel access procedure, T_{SI}=16 μs; in the case of Type 2C dynamic channel access procedure, 0≤T_{SI}≤16 μs. Given this, the LBT type may be indicated by the second configuration.

In order to ensure that the UE starts to transmit S-SSB from the starting boundary of an S-SSB occasion, the second configuration may also indicate information for calculating a length of a CPE before transmitting the S-SSB. For example, the CPE may be an extension of CP of a first symbol in an S-SSB occasion for which LBT type 2 is performed. In some embodiments of the present application, the length of the CPE may be set based on a priority of a synchronization reference of the UE.

In addition, if the second configuration is used to initiate a COT-based S-SSB transmission, the MCOT for S-SSB may also be indicated by the second configuration.

Given the above, the second configuration may include at least one of: an LBT type; a unit of time (e.g., denoted as T_{UT}) for calculating a length of a CPE (e.g., denoted as T_{CPE}); a mapping between the number(s) (e.g., denoted as N_{UT}) of units of time for calculating a length of a CPE and priority(ies) for synchronization reference; or an MCOT for S-SSB.

As stated above, the LBT type may be Type 2A, Type 2B, or Type 2C dynamic channel access procedure, which is used for determining a sensing interval for performing an LBT procedure.

The MCOT for S-SSB may be defined as a maximum number of S-SSBs to be transmitted within one COT, or defined as a maximum channel occupancy time for consecutive S-SSB transmissions.

The principle for setting T_{CPE} is that the higher the priority for synchronization reference, the longer the T_{CPE}. That is, the principle may provide an earlier channel access opportunity to a synchronization reference with a higher priority.

There are four basic synchronization references from which a UE may derive its own synchronization, i.e., global navigation satellite system (GNSS), its serving BS (e.g., eNB or gNB), another UE transmitting SLSS (e.g., which is referred to as a SyncRef UE), or its own internal clock. In general, GNSS or BS is regarded as the highest-quality sources. SyncRef UEs are distinguished between those which are directly synchronized to GNSS or BS, those which are 1 further step away, and those which are ≥2 further steps away from GNSS or BS. As a last resort, a UE unable to find any other synchronization reference will use its own internal clock to transmit SLSS. The preference order for synchronization references is as follows, with details specified in TS 36.331, wherein “Level 1” through “Level 5” are priorities for synchronization references from the highest to the lowest.

Level 1: the synchronization reference is either GNSS or BS, according to configuration or pre-configuration.
Level 2: the synchronization reference is a SyncRef UE directly synchronized to a Level 1 source.
Level 3: the synchronization reference is a SyncRef UE synchronized to a Level 2 source, i.e., indirectly synchronized to a Level 1 source.
Level 4: the synchronization reference is any other SyncRef UE.
Level 5: UE's internal clock.

In some embodiments of the present application, the length of a CPE may be determined by the following equation (2):

$${T}_{CPE} = {N}_{UT} * {T}_{U T} \qquad ( 2 )$$

In some examples, T_{UT}=9 μs. The number of units of time “N_{UT}” in the above equation may be determined based on the mapping between the number(s) of units of time for calculating a length of a CPE and priority(ies) for synchronization reference. According to some embodiments of the present application, a higher priority for synchronization reference is mapped to the number of units of time associated with a longer CPE, thereby realizing the principle that the higher the priority for synchronization reference, the longer the T_{CPE} .

Then, once the UE determines its synchronization reference, the priority for the synchronization reference is determined. Based on the mapping included in the second configuration, the number of units of time “N_{UT}” corresponding to the priority is determined.

The following Table 4 shows an exemplary mapping between CPE (represented by the number of units of time (e.g., N_{UT})) and priorities for synchronization reference.

TABLE 4

| CPE (N_{UT}) | Priority for synchronization reference |
|---|---|
| 4 | Level 1 |
| 3 | Level 2 |
| 2 | Level 3 |
| 1 | Level 4 |
| 0 | Level 5 |

For example, in the case that the priority for the synchronization reference is level 2, the number of units of time “N_{UT}” is 3 according to Table 4. Based on equation (2), the UE may determine that T_{CPE}=27 μs.

After obtaining the second configuration, in step 403, the UE may perform an LBT type 2 associated with an S-SSB occasion based on the second configuration. For example, based on the second configuration, the UE may determine a length of a sensing interval, i.e., T_{SI}, and a length of the CPE, i.e., T_{CPE}. Then, the UE may perform an LBT procedure (i.e., LBT type 2) associated with the S-SSB occasion within the sensing interval, where the earliest starting point for the LBT procedure is T_{SI}+T_{CPE} relative to the starting boundary of the S-SSB occasion. In response to the LBT procedure being successful, the UE may transmit a CPE to occupy a channel until the starting boundary of the S-SSB occasion. In step 405, the UE may transmit an S-SSB on the S-SSB occasion.

FIG. 7 illustrates an exemplary time domain structure for performing LBT type 2 according to some embodiments of the present application.

Referring to FIG. 7, when the UE intends to transmit an S-SSB on an S-SSB occasion, the UE may perform LBT type 2 prior to the S-SSB occasion.

Based on the LBT type indicated by the second configuration, the UE may determine a length of a sensing interval, i.e., T_{SI}. The length of the CPE, i.e., T_{CPE}, may be determined based on the second configuration as stated above. That is to say, the earliest starting point for the UE to occupy the channel is T_{CPE} relative to the starting boundary of the S-SSB occasion. Then, the UE may perform an LBT procedure (i.e., LBT type 2) associated with the S-SSB occasion within the sensing interval, where the earliest starting point for idle sensing is T_{SI}+T_{CPE} relative to the starting boundary of the S-SSB occasion. In response to the LBT procedure being successful, the UE may transmit a CPE to occupy a channel until the starting boundary of the S-SSB occasion. In the example of FIG. 7, the CPE is an extension of a CP of a first symbol in the S-SSB occasion. Then, the UE may transmit an S-SSB on the S-SSB occasion.

The third configuration may be used for supporting LBT type 1. For example, the third configuration may be used for supporting LBT type 1 associated with a first S-SSB occasion within a COT (e.g., before transmitting a first S-SSB within a COT). That is, the third configuration may be used to initiate a COT-based S-SSB transmission.

In order to support the LBT type 1, the LBT type may be indicated by the third configuration. Moreover, since the third configuration is used to initiate a COT-based S-SSB transmission, the MCOT for S-SSB may also be indicated by the third configuration.

As stated in the above embodiments, for LBT type 1, a length of the sensing interval (e.g., denoted as T_{SI}) may be determined based on a CAPC value as shown in Table 1 or Table 2. In some embodiments of the present application, a CAPC value may be determined based on at least one of: a priority of a synchronization reference of the UE, or a length of a COT for S-SSB. The length of a COT for S-SSB may be defined as a number of S-SSBs (or S-SSB occasions) to be transmitted within the COT, or defined as a channel occupancy time for consecutive S-SSB transmissions in the COT. The length of a COT for SSB is constrained by MCOT (e.g., less than or equal to MCOT) and may be determined by UE's intension for S-SSB transmission.

Given the above, the third configuration may include at least one of: an LBT type; a first mapping between CAPC value(s) and priority(ies) for synchronization reference; a second mapping between CAPC value(s) and length(s) of COT(s) for S-SSB; or an MCOT for S-SSB.

The LBT type in the third configuration may be set as LBT type 1. The MCOT for S-SSB may be defined as a maximum number of S-SSBs to be transmitted within one COT, or defined as a maximum channel occupancy time for consecutive S-SSB transmissions

In some embodiments of the present application, one principle of mapping between CAPC values and priorities for synchronization reference is providing an earlier channel access opportunity for a synchronization reference with a higher priority. In order to achieve the above principle, a higher priority for synchronization reference may be mapped to a smaller CAPC value. Based on Table 1 or Table 2, a smaller CAPC value may correspond to a shorter sensing interval, thereby providing an earlier channel access opportunity.

The following Table 5 shows an exemplary mapping between CAPC values (e.g., p) and priorities for synchronization reference

TABLE 5

| CAPC (p) | Priority for synchronization reference |
|---|---|
| 1 | Level 1 |
| 2 | Level 2 |
| 2 | Level 3 |
| 3 | Level 4 |
| 4 | Level 5 |

For example, in the case that the priority for synchronization reference is level 2, the corresponding CAPC value is 2 according to Table 5. Based on the CAPC value, the UE may determine a length of the sensing interval based on Table 1 or Table 2.

In some embodiments of the present application, one principle of mapping between CAPC values and lengths of COTs for S-SSB is providing an earlier channel access opportunity for a COT with a shorter length, e.g., a smaller number of S-SSBs in the COT. In order to achieve the above principle, a shorter length of a COT for S-SSB (e.g., a COT with a smaller number of S-SSBs) is mapped to a smaller CAPC value. Based on Table 1 or Table 2, a smaller CAPC value may correspond to a shorter sensing interval, thereby providing an earlier channel access opportunity.

The following Table 6 shows an exemplary mapping between CAPC values (e.g., p) and lengths of COTs for S-SSB, which is defined as the number of S-SSBs (i.e., j) within a COT.

TABLE 6

| CAPC (p) | Length of COT for S-SSB (j) |
|---|---|
| 1 | j = [1 . . . floor(N_{S-SSB}^{MCOT}/4)] |
| 2 | j = [(floor(N_{S-SSB}^{MCOT}/4) . . . 2* floor(N_{S-SSB}^{MCOT}/4)] |
| 3 | j = [(2*floor(N_{S-SSB}^{MCOT}/4) . . . 3* floor(N_{S-SSB}^{MCOT}/4)] |
| 4 | j = [(3*floor(N_{S-SSB}^{MCOT}/4) . . . N_{S-SSB}^{MCOT}] |

Referring to Table 6, j is the number of S-SSBs (or S-SSB occasions) in the COT and N_{S-SSB}^{MCOT} is the number of S-SSBs (or S-SSB occasions) included in the MCOT. For example, assuming that there are 8 S-SSBs in the MCOT and a COT has 3 S-SSBs, which is within a value range in the second row (e.g., j=[2, 3, 4]) of Table 6, then the corresponding CAPC value is 2. Based on the CAPC value, the UE may determine a length of the sensing interval based on Table 1 or Table 2.

After obtaining the third configuration, in step 403, the UE may perform an LBT type 1 associated with an S-SSB occasion based on the third configuration. For example, based on the third configuration, the UE may determine a CAPC value, i.e., p. Then, the UE may perform an LBT type 1 associated with the S-SSB occasion within a sensing interval based on the CAPC value. In the case that there is a gap between the end of the sensing interval and the starting boundary of the S-SSB occasion, the UE may transmit a CPE to occupy a channel until the starting boundary of the S-SSB occasion in response to the LBT procedure being successful. In step 405, the UE may transmit an S-SSB on the S-SSB occasion. In the case that there is no gap between the end of the sensing interval and the starting boundary of the S-SSB occasion, the UE may transmit an S-SSB on the S-SSB occasion in response to the LBT type 1 being successful.

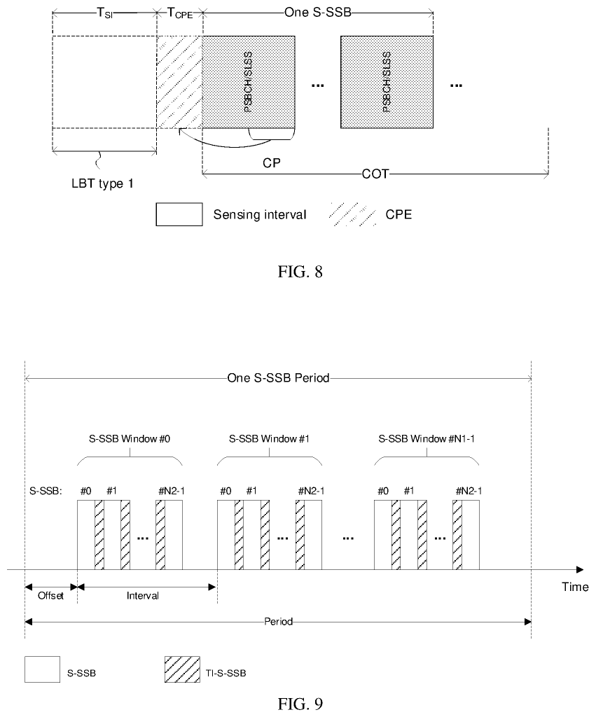

FIG. 8 illustrates an exemplary time domain structure for performing LBT type 1 according to some embodiments of the present application.

Referring to FIG. 8, when the UE intends to transmit an S-SSB on an S-SSB occasion, the UE may perform LBT type 1 prior to the S-SSB occasion.

Based on the third configuration, the UE may determine a CAPC value as stated above. The UE may perform an LBT procedure (i.e., LBT type 1) associated with the S-SSB occasion in a sensing interval based on the CAPC value. In response to the LBT procedure being successful, the UE may transmit a CPE to occupy a channel until a starting boundary of the S-SSB occasion. In the example of FIG. 8, the CPE is an extension of a CP of a first symbol in the S-SSB occasion. Then, the UE may initiate a COT-based S-SSB transmission. For example, the UE may transmit an S-SSB (e.g., a first S-SSB in the COT) on the S-SSB occasion.

According to some embodiments of the present application, the configuration information obtained in step 401 may also include at least one of: a maximum number of S-SSBs to be transmitted by the UE within one S-SSB period; or a maximum number of S-SSBs to be transmitted by the UE within one S-SSB window. Such kind of information may be used to define the number of S-SSBs within one S-SSB period or within one S-SSB window that a UE can transmit, and thus the S-SSBs within one S-SSB period or within one S-SSB window may support transmissions for one or more UEs.

FIG. 9 illustrates an exemplary distribution of S-SSB occasions within one S-SSB period including a plurality of S-SSB windows according to some embodiments of the present application.

Referring to FIG. 9, in the S-SSB period, N1 S-SSB windows are included, which are S-SSB window #0, S-SSB window #1, . . . , S-SSB window #N1-1, respectively. In each S-SSB window, N2 S-SSB occasions are included, which are S-SSB occasion #0, S-SSB occasion #1, . . . , S-SSB occasion #N2-1, respectively. In each S-SSB window, a time interval (e.g., denoted as TI-S-SSB) locates between two adjacent S-SSB occasions. For example, the structure of the time interval may be determined based on the first configuration as described above. The length of the S-SSB period is marked as “Period.” The time duration from the starting slot of the S-SSB period to the starting slot of the S-SSB window #0 is marked as “Offset.” The interval between two adjacent S-SSB windows (e.g., from the starting slot of the S-SSB window #0 to the starting slot of the S-SSB window #1) is marked as “Interval.”

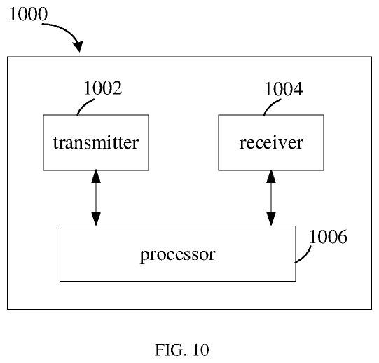

FIG. 10 illustrates a simplified block diagram of an exemplary apparatus 1000 for S-SSB transmission in an unlicensed spectrum according to some embodiments of the present application. In some embodiments, the apparatus 1000 may be or include at least part of a UE (e.g., UE 101a or UE 101b in FIG. 1). In some other embodiments, the apparatus 1000 may be or include at least part of a BS (e.g., BS 102 in FIG. 1).

Referring to FIG. 10, the apparatus 1000 may include at least one transmitter 1002, at least one receiver 1004, and at least one processor 1006. The at least one transmitter 1002 is coupled to the at least one processor 1006, and the at least one receiver 1004 is coupled to the at least one processor 1006.

Although in this figure, elements such as the transmitter 1002, the receiver 1004, and the processor 1006 are illustrated in the singular, the plural is contemplated unless a limitation to the singular is explicitly stated. In some embodiments of the present application, the transmitter 1002 and the receiver 1004 may be combined to one device, such as a transceiver. In some embodiments of the present application, the apparatus 1000 may further include an input device, a memory, and/or other components. The transmitter 1002, the receiver 1004, and the processor 1006 may be configured to perform any of the methods described herein (e.g., the method described with respect to any of FIGS. 4-9).

According to some embodiments of the present application, the apparatus 1000 may be a UE, and the transmitter 1002, the receiver 1004, and the processor 1006 may be configured to perform operations of the method performed by a UE as described with respect to any of FIGS. 4-9. For example, the processor 1006 may be configured to: obtain configuration information for S-SSB in an unlicensed spectrum based on configuration or pre-configuration, wherein the configuration information includes at least one of the following: a first configuration associated with a time interval between adjacent S-SSB occasions sharing a same COT; a second configuration for performing LBT type 2; or a third configuration for performing LBT type 1; and perform an LBT procedure associated with an S-SSB occasion based on the configuration information. The transmitter 1002 may be configured to transmit an S-SSB on the S-SSB occasion in response to the LBT procedure being successful.

According to some embodiments of the present application, the apparatus 1000 may be a BS, and the transmitter 1002, the receiver 1004, and the processor 1006 may be configured to perform operations of the method performed by a BS as described with respect to any FIGS. 4-9. For example, the transmitter 1002 may be configured to transmit configuration information for S-SSB in an unlicensed spectrum, wherein the configuration information includes at least one of the following: a first configuration associated with a time interval between adjacent S-SSB occasions sharing a same COT; a second configuration for performing LBT type 2; or a third configuration for performing LBT type 1.

In some embodiments of the present application, the apparatus 1000 may further include at least one non-transitory computer-readable medium. In some embodiments of the present disclosure, the non-transitory computer-readable medium may have stored thereon computer-executable instructions to cause the processor 1006 to implement any of the methods as described above. For example, the computer-executable instructions, when executed, may cause the processor 1006 to interact with the transmitter 1002 and/or the receiver 1004, so as to perform operations of the methods, e.g., as described with respect to FIGS. 4-9.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for S-SSB transmission in an unlicensed spectrum, including a processor and a memory. Computer programmable instructions for implementing a method for S-SSB transmission in an unlicensed spectrum are stored in the memory, and the processor is configured to perform the computer programmable instructions to implement the method for S-SSB transmission in an unlicensed spectrum. The method for S-SSB transmission in an unlicensed spectrum may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for S-SSB transmission in an unlicensed spectrum according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
obtain configuration information for sidelink synchronization signal block (S-SSB) in an unlicensed spectrum, wherein the configuration information includes at least one of the following:
a first configuration associated with a time interval between adjacent S-SSB occasions sharing a same channel occupancy time (COT);
a second configuration for performing listen before talk (LBT) type 2; or
a third configuration for performing LBT type 1;
perform an LBT procedure associated with an S-SSB occasion based on the configuration information; and
transmit an S-SSB on the S-SSB occasion in response to the LBT procedure being successful.

2. The UE of claim 1, wherein the configuration information is based on at least one of the following granularities:
per channel bandwidth,
per carrier,
per bandwidth part,
per frequency range, or
per subcarrier spacing (SCS); or
wherein the at least one processor is configured to cause the UE to receive the configuration information via at least one of: a master information block (MIB) message, a system information block (SIB) message, a radio resource control (RRC) signaling, or a medium access control (MAC) control element (CE).

3. The UE of claim 1, wherein the first configuration indicates at least one of:
a length of the time interval;
a location of the time interval; or
a construction of the time interval.

4. The UE of claim 3, wherein the time interval occupies one or more orthogonal frequency division multiplexing (OFDM) symbols, and a number of OFDM symbols included in the time interval is determined based on a maximum length of a sensing interval for performing an LBT procedure and SCS.

5. The UE of claim 3, wherein the construction of the time interval includes at least one of: a length of a sensing interval for performing an LBT procedure, a location of the sensing interval, or a content for padding in the time interval.

6. The UE of claim 5, wherein:
the location of the sensing interval is immediately after a previous symbol adjacent to the time interval or immediately prior to a next symbol adjacent to the time interval; or
the content for padding in the time interval is a full or partial copy of a symbol adjacent to the time interval or a cyclic prefix extension (CPE) of a first symbol in an S-SSB occasion next to the time interval.

7. The UE of claim 1, wherein the second configuration indicates at least one of:
an LBT type;
a unit of time for calculating a length of a cyclic prefix extension (CPE);
a mapping between a number of units of time for calculating a length of a CPE and priorities for synchronization reference; or
a maximum channel occupancy time (MCOT) for S-SSB.

8. The UE of claim 7, wherein a higher priority for synchronization reference is mapped to the number of units of time associated with a longer CPE.

9. The UE of claim 1, wherein the third configuration indicates at least one of:
an LBT type;
a first mapping between channel access priority class (CAPC) value(s) and priority(ies) for synchronization reference;
a second mapping between CAPC value(s) and length(s) of COT(s) for S-SSB; or an MCOT for S-SSB.

10. The UE of claim 9, wherein a higher priority for synchronization reference is mapped to a smaller CAPC value.

11. The UE of claim 9, wherein a shorter length of a COT for SSB is mapped to a smaller CAPC value.

12. The UE of claim 7, wherein the MCOT for S-SSB is defined as a maximum number of S-SSBs to be transmitted within one COT or defined as a maximum channel occupancy time for consecutive S-SSB transmissions.

13. The UE of claim 7, wherein the at least one processor is configured to cause the UE to:
perform the LBT procedure associated with the S-SSB occasion in a sensing interval, wherein a length of the sensing interval is determined based on the LBT type; and
transmit the CPE to occupy a channel until a starting boundary of the S-SSB occasion in response to the LBT procedure being successful.

14. A base station (BS), comprising:
at least one memory; and
at least one processor coupled with the at least one memory and configured to cause the base station to:
transmit configuration information for sidelink synchronization signal block (S-SSB) in an unlicensed spectrum, wherein the configuration information includes at least one of the following:
a first configuration associated with a time interval between adjacent S-SSB occasions sharing a same channel occupancy time (COT);
a second configuration for performing listen before talk (LBT) type 2; or
a third configuration for performing LBT type 1.

15. A method performed by a user equipment (UE), the method comprising:
obtaining configuration information for sidelink synchronization signal block (S-SSB) in an unlicensed spectrum, wherein the configuration information includes at least one of the following:
a first configuration associated with a time interval between adjacent S-SSB occasions sharing a same channel occupancy time (COT);
a second configuration for performing listen before talk (LBT) type 2; or
a third configuration for performing LBT type 1;
performing an LBT procedure associated with an S-SSB occasion based on the configuration information; and
transmitting an S-SSB on the S-SSB occasion in response to the LBT procedure being successful.

16. A processor for wireless communication, comprising:
at least one controller coupled with at least one memory and configured to cause the processor to:
obtain configuration information for sidelink synchronization signal block (S-SSB) in an unlicensed spectrum, wherein the configuration information includes at least one of the following:
a first configuration associated with a time interval between adjacent S-SSB occasions sharing a same channel occupancy time (COT);
a second configuration for performing listen before talk (LBT) type 2; or
third configuration for performing LBT type 1;
perform an LBT procedure associated with an S-SSB occasion based on the configuration information; and
transmit an S-SSB on the S-SSB occasion in response to the LBT procedure being successful.

17. The processor of claim 16, wherein the configuration information is based on at least one of the following granularities:
per channel bandwidth,
per carrier,
per bandwidth part,
per frequency range, or
per subcarrier spacing (SCS); or
wherein the at least one controller is configured to cause the processor to receive the configuration information via at least one of: a master information block (MIB) message, a system information block (SIB) message, a radio resource control (RRC) signaling, or a medium access control (MAC) control element (CE).

18. The processor of claim 16, wherein the second configuration indicates at least one of:
an LBT type;
a unit of time for calculating a length of a cyclic prefix extension (CPE);
a mapping between a number of units of time for calculating a length of a CPE and priorities for synchronization reference; or
a maximum channel occupancy time (MCOT) for S-SSB.

19. The processor of claim 18, wherein the third configuration indicates at least one of:
an LBT type;
a first mapping between channel access priority class (CAPC) value(s) and priority(ies) for synchronization reference;
a second mapping between CAPC value(s) and length(s) of COT(s) for S-SSB; or
an MCOT for S-SSB.

20. The processor of claim 18, wherein the at least one controller is configured to cause the processor to:
perform the LBT procedure associated with the S-SSB occasion in a sensing interval, wherein a length of the sensing interval is determined based on the LBT type; and
transmit the CPE to occupy a channel until a starting boundary of the S-SSB occasion in response to the LBT procedure being successful.
